(19) United States
(12) Patent Application Publication
(10) Pub. No.: US 2010/0214401 A1
(43) Pub. Date: Aug. 26, 2010

(54) FIBER OPTIC PLATE, AND PALM PRINT AND FINGER PRINT READING APPARATUS

(75) Inventor: Takeo Sugawara, Hamamatsu-shi (JP)

Correspondence Address: DRINKER BIDDLE & REATH (DC), 1500 K STREET, N.W., SUITE 1100, WASHINGTON, DC, 20005-1209, US

(73) Assignee: HAMAMATSU PHOTONICS K.K., Hamamatsu-shi (JP)

(21) Appl. No.: 12/711,280

(22) Filed: Feb. 24, 2010

(30) Foreign Application Priority Data
Feb. 26, 2009 (JP) P2009-043806

(51) Int. Cl. H04N 7/18

(52) U.S. Cl. 348/77; 348/E07.085

(57) ABSTRACT

[Object] To enable to obtain a clear output image when a palm print is taken.

[Solution Means] An FOP 1 includes a plurality of unit fibers 4 respective optical axes of which are approximately parallel to each other, and an input end surface 2 and an output end surface 3 configured by respectively assembling both end surfaces of the unit fibers. The FOP 1 has a conical shape having a height in the optical axis direction; the input end surface 2 configures a side surface of the conical shape; and the output end surface 3 configures a bottom surface of the conical shape. A light incident from the input end surface 2 is output from the output end surface 3 if a palm or the like of a photographic subject is brought into contact with the input end surface 2. The unit fiber 4 has a core 5 for propagating the light which is incident from the input end surface 2, a cladding 6 for covering an external periphery of the core 5, and a light absorbing body 7 for absorbing an incident light while covering an external periphery of the cladding 6. The input end surface 2 is inclined with respect to the optical axis of the core 5 and the angle of inclination is set so that the light incident from air into the core 5 does not generate total reflection at a boundary surface between the core 5 and the cladding 6.

### BACKGROUND OF THE INVENTION

1. Field of the Invention

The present invention relates to a fiber optic plate, and a palm print and finger print reading apparatus.

2. Related Background Art

FIG. 15 shows finger prints and palm prints taken, for example, by a judicial organization. To obtain finger prints or palm prints as in the figure, a method is conventionally known of taking an image of a finger or a palm which is placed on a flat glass plate or a prism by a camera or a scanner. Patent Document 1 discloses a palm print taking apparatus as an example thereof. If a palm is placed on a window on a housing of the apparatus, a camera provided in the housing takes an image of the palm.

Moreover, as shown in the Patent Document 2, for example, a fiber optic plate has been conventionally known. The fiber optic plate is an optical device including a plurality of optical fibers which are bundled. By use of the fiber optic plate as an optical element instead of a lens, it becomes possible to transmit a light or an image with high efficiency and low distortion. As shown in FIG. 16, a conventional fiber optic plate 80 includes a plurality of optical fibers 85 which are bundled to be integrated and one end thereof is cut while being inclined with respect to an optical axis to form an input end surface 81. If a finger 82 or the like is brought into close contact with the input end surface 81, convex and concave patterns of the closely contacted portion appear on an output end surface 83 on the opposite side. As a result, an image of a finger print 84 can be read.

### Prior Art Documents

### Patent Documents

Patent Document 1: Japanese Translation of International Application (Kohyo) No. 2006-500662

Patent Document 2: U.S. Pat. No. 4,932,776

### SUMMARY OF THE INVENTION

### Technical Problem

In a case where the palm print taking apparatus disclosed in the Patent Document 1 is used, an image is taken while a light from a ring light is applied from the bottom. Therefore, the image thus taken has a low contrast. Especially in a case where a palm which is a photographic subject is sweaty or dry, there is a higher tendency for low contrasts. It is conceivable that the contrast can be improved to increase a recognition rate by use of a special skin conditioner, however, this is inconvenient for use.

Moreover, in a case where a finger print or a palm print is taken by use of the conventional fiber optic plate disclosed in the Patent Document 2, a finger or a palm is placed on a flat surface or a concave portion when a finger print or a palm print is taken. Especially in a case where a palm print is taken, because the center of the palm is concave, it is difficult to take a palm print clearly.

Therefore, the present invention has been made in consideration of the above and is aimed at providing a fiber optic plate capable of obtaining a clear output image when a palm print is taken.

### Means for Solving the Problem

To solve the above-mentioned problem, a fiber optic plate of the present invention includes a plurality of unit fibers, which are bundled in a condition where respective optical axes of the unit fibers are parallel to each other, and an input end surface and an output end surface configured by respectively assembling both end surfaces of the unit fibers, wherein the fiber optic plate has a conical shape having a height in the optical axis direction; the input end surface configures a side surface of the conical shape; the output end surface configures a bottom surface of the conical shape; a light incident from the input end surface is output from the output end surface if either or both of a finger and a palm of a photographic subject are brought into contact with the input end surface; the unit fiber has a core for propagating the light which is incident from the input end surface, a cladding for covering an external periphery of the core, and a light absorbing body for absorbing an incident light while covering an external periphery of the cladding; and the input end surface is inclined with respect to the optical axis of the core and the angle of inclination is set so that the light incident from air into the core does not generate total reflection at a boundary surface between the core and the cladding.

The fiber optic plate of the present invention has a conical shape and the side surface of the conical shape is the input end surface. Therefore, when a palm print is taken, the palm of a photographic subject is easily brought into close contact with the inclined input end surface. As a result thereof, it becomes possible to prevent generation of a space between the input end surface and the concave portion at the center of the palm. That is, since the inclined input end surface has a convex shape and the convex portion thereof fits the concave portion at the center of the palm of the photographic subject, a space is hardly generated between the input end surface and the concave portion at the center of the palm. Therefore, it becomes possible to obtain a clearer output image compared to a case where a palm is placed on a flat surface or concave portion when a palm print is taken.

Moreover, since the light absorbing body is provided so as to cover the external periphery of the cladding in the unit fiber, a light leaked from the core and a light propagating the cladding reach the light absorbing body fiber. These lights are absorbed when the lights are incident into the light absorbing body and therefore, the adjacent optical fibers are optically insulated from each other by the light absorbing body. Therefore, the light which propagates each of the cores and leaks from the core is prevented from being incident into another adjacent core. Moreover, if the inclination angle of the input end surface of the fiber optic plate is set as above, part of the light which has propagated through air to be incident into the core from the input end surface leaks from the core to the cladding and is absorbed by the light absorbing body. Therefore, unnecessary light such as a background light is gradually attenuated in the process of propagating through the core and is hardly output from the output end surface. On the other hand, when a surface of an object is brought into close contact with the input end surface, a light which passed through the closely contacted portion is incident into the core. However, the incident light includes a light which is incident at an angle which satisfies a condition for the total reflection on the boundary surface between the core and the cladding. That is, only the light incident from the closely contacted portion is output from the output end surface. Thus, even if a palm which is a photographic subject is sweaty or dry, it becomes possible to obtain a clear output image when a palm print is taken.

Moreover, placing not only a palm but all the fingers on the input end surface being the side surface of the conical shape enables to obtain both a palm print and finger prints simultaneously. Especially regarding finger prints, finger prints of all five fingers can be taken simultaneously.

### Advantageous Effects of Invention

According to the present invention, it becomes possible to provide a fiber optic plate capable of obtaining a clear output image when a palm image is taken.

### BRIEF DESCRIPTION OF THE DRAWINGS

FIG. 1 is a partly sectional perspective view of an FOP 1 according to one embodiment.

FIG. 2 is a rear elevational view of the FOP 1 of FIG. 1.

FIG. 3 is an enlarged view of a part A of FIG. 2.

FIG. 4 is a partly cross-sectional view of the FOP 1 of FIG. 1.

FIG. 5 is a table showing a material composition of a core 5, a cladding 6, and a light absorbing body 7 in percent by weight as well as a refraction index of the core 5 and cladding 6 of the FOP 1 of FIG. 1.

FIG. 6 is a partly longitudinal-sectional view of the FOP 1 of FIG. 1.

FIG. 7 is a partly longitudinal-sectional view of the FOP 1 of FIG. 1 partly showing a condition where a surface of a finger or a palm 10 is brought into a close contact with an input end surface 2 of the FOP 1 of FIG. 1 in an enlarged manner.

FIG. 8 is a schematic configurational view showing a palm print and finger print reading apparatus including the FOP 1 of FIG. 1.

FIG. 9 is a schematic configurational view showing a palm print and finger print reading apparatus including the FOP 1 of FIG. 1.

FIG. 10 is a partly sectional perspective view of an FOP 100 according to another embodiment.

FIG. 11 is a rear elevational view of the FOP 100 of FIG. 10.

FIG. 12 is an enlarged view of a part C of FIG. 11.

FIG. 13 is a partly sectional perspective view of an FOP 200 according to still another embodiment.

FIG. 14 is a rear elevational view of the FOP 200 according to the same embodiment as FIG. 13.

FIG. 15 is a view showing a case where a finger print or a palm print is taken, for example, by a judicial organization.

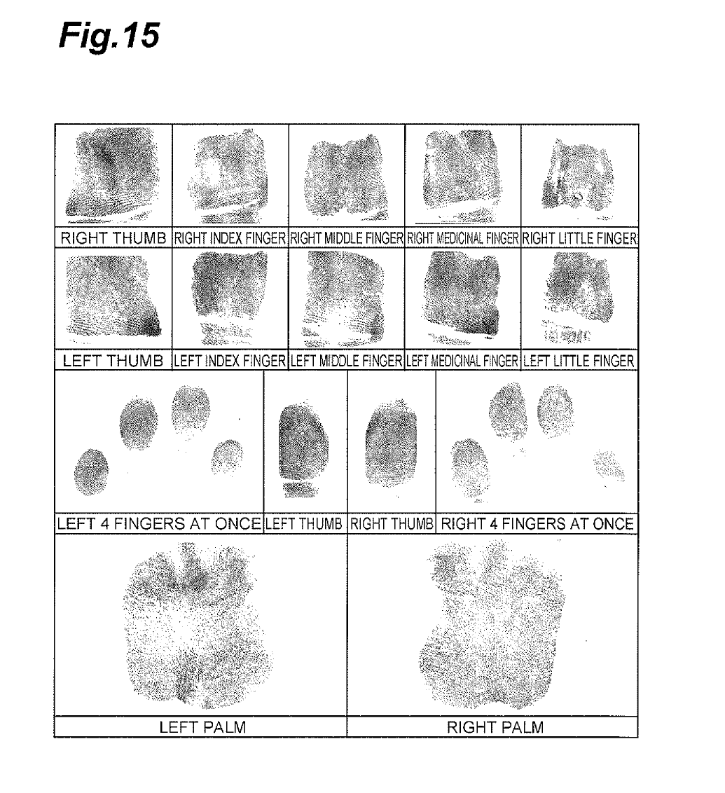

FIG. 16 is a view showing a conventional fiber optic plate 80.

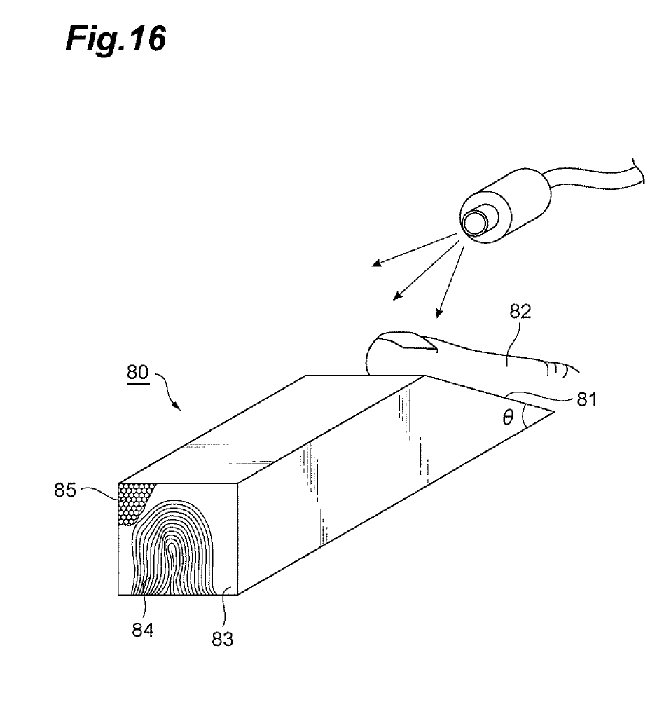

### DESCRIPTION OF THE PREFERRED EMBODIMENTS

1 . . . FOP, 2 . . . input end surface, 3 . . . output end surface, 4 . . . unit optical fiber, 5 . . . core, 6 . . . cladding, 7 . . . light absorbing body

### DESCRIPTION OF THE PREFERRED EMBODIMENTS

Hereinafter, preferred embodiments of a fiber optic plate according to the present invention will be described in detail with reference to the attached drawings. Here, the same reference numerals are given to the same elements in the drawings and overlapping description is omitted.

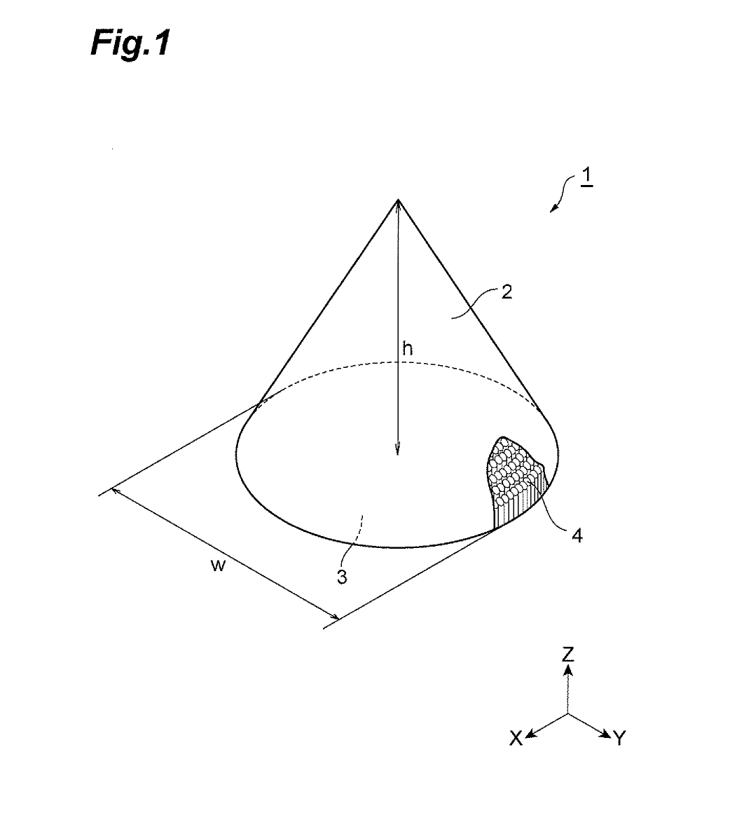

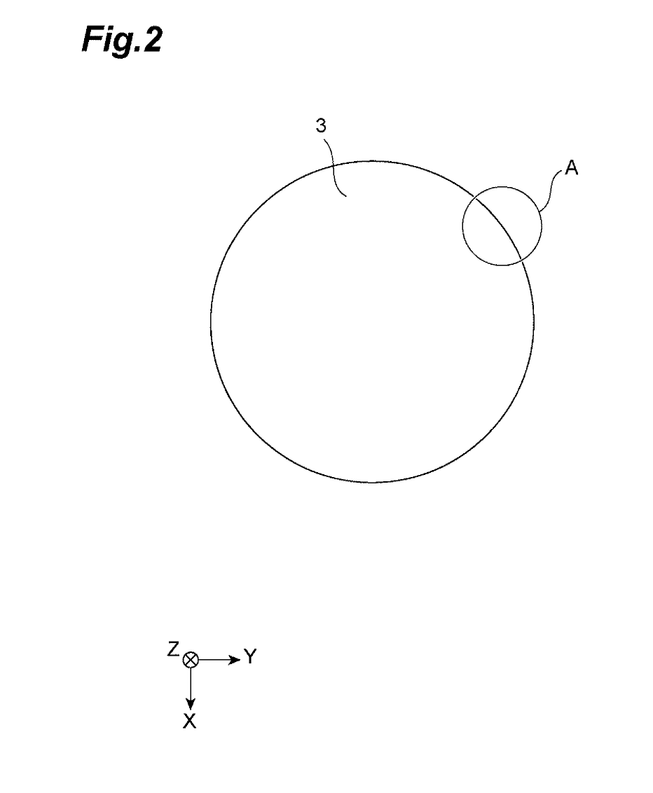

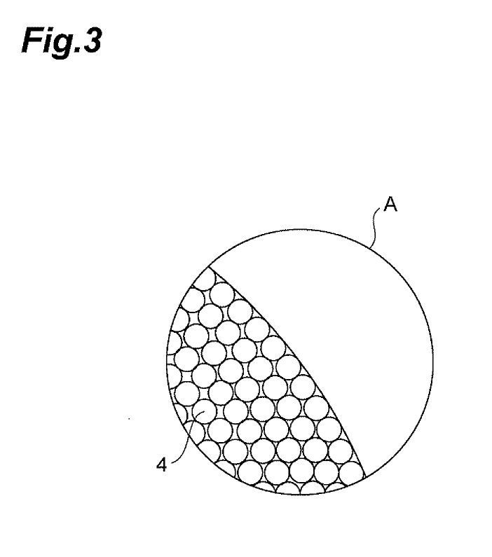

An appearance of a fiber optic plate (hereinafter referred to as an “FOP”) 1 will be described using FIGS. 1 to 3. FIG. 1 is a partly sectional perspective view of the FOP 1, FIG. 2 is a rear elevational view of the FOP 1, and FIG. 3 is an enlarged view of a part A of FIG. 2. The FOP 1 is used for a later-described palm print and finger print reading apparatus and includes a plurality of unit optical fibers 4, which are bundled in a condition where respective optical axes of the unit optical fibers are approximately parallel to each other, and an input end surface 2 and an output end surface 3 configured by respectively assembling both end surfaces of the unit optical fibers 4, as shown in FIGS. 1 to 3. The respective optical axes of the unit optical fibers are basically parallel to each other, but by some reasons, for example manufacturing conditions, etc., there can be minute difference among the directions of the respective optical axes. The FOP 1 has a conical shape with a height h in the optical axis direction (Z direction) of the unit optical fiber 4 and the input end surface 2 configures a side surface of the conical shape while the output end surface 3 configures a bottom surface of the conical shape. The FOP 1 is configured to output a light incident from the input end surface 2 from the output end surface 3 if either or both of a finger and a palm of a photographic subject is brought into contact with the input end surface 2. Here, the input end surface 2 is inclined with respect to the optical axis of the fiber (to be described later) and the output end surface 3 is formed to be approximately perpendicular to the optical axis.

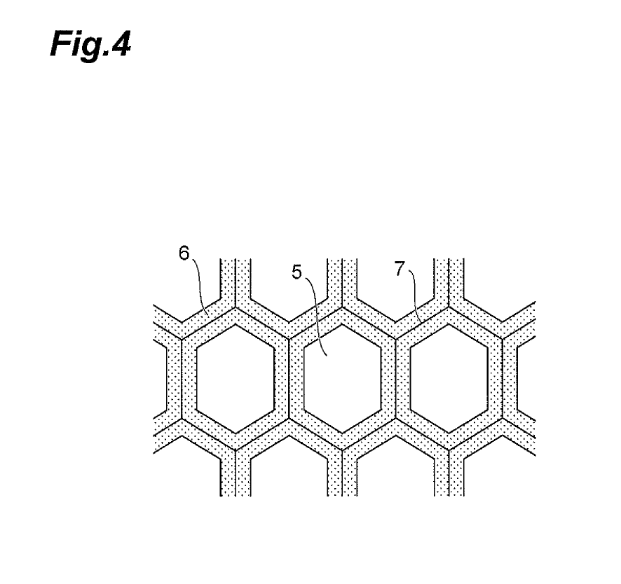

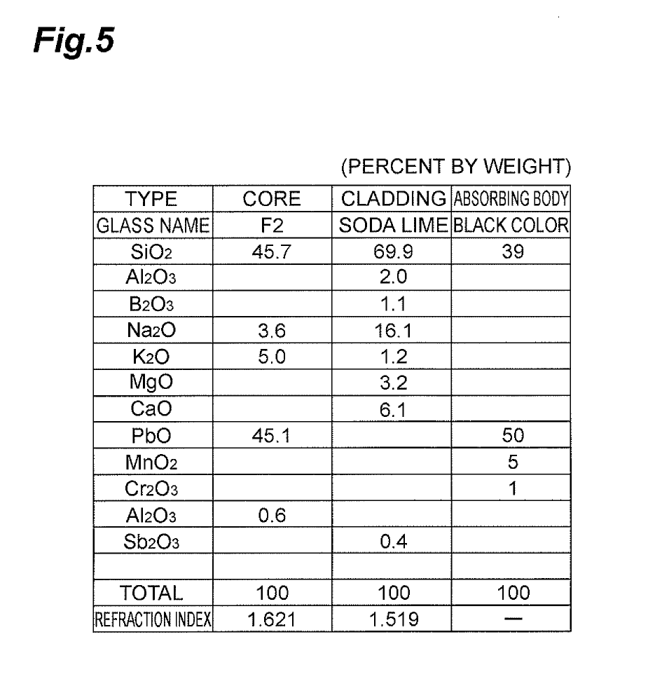

The FOP 1 includes a core 5 for propagating a light incident from the input end surface 2, a cladding 6 for covering an external periphery thereof, and a light absorbing body 7 provided so as to cover an external periphery of the cladding 6, as shown in FIG. 4. Since the light absorbing body 7 is provided so as to cover the external periphery of the cladding 6, a light leaked from the core 5 and the light incident into the cladding 6 are absorbed by the light absorbing body 7. Therefore, the optical fibers adjacent to each other are kept in an optically insulated condition by the light absorbing body 7. Here, the core 5, the cladding 6, and the light absorbing body 7 are respectively made of materials shown in FIG. 5 and as a result thereof, refraction index of the core 5 is 1.621 and refraction index of the cladding 6 is 1.519. Moreover, as an example of the size of the FOP 1, the height h in FIG. 1 is, for example, between 15 and 20 cm and the width w is between 20 and 25 cm.

As mentioned above, the FOP 1 includes an optical fiber having the cladding 6 with the external periphery surrounded by the light absorbing body 7 so that the light incident into each of the cores 5 is prevented from leaking from the core 5 and being incident into an adjacent core 5. Thus, it becomes possible to prevent generation of cross-talk between adjacent fibers and to improve the SN ratio of an output image. This operation is carried out irrespective of the inclination angle of the input end surface 2 (inclination angle with respect to the optical axis of the optical fiber). Moreover, setting the inclination angle of the input end surface 2 to be a specific value allows the FOP 1 to demonstrate later-described superior operation and effect.

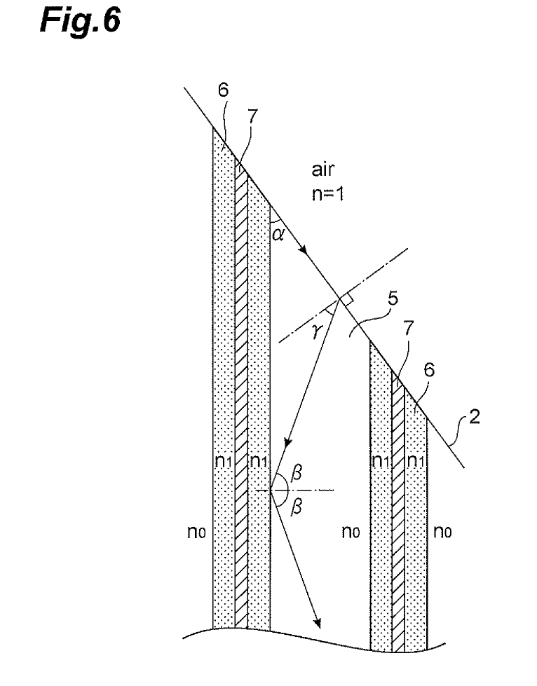

FIG. 6 shows a longitudinal section of the FOP 1. In the figure, n0 indicates a refraction index of the core 5, n1 indicates a refraction index of the cladding 6, and n indicates a refraction index of air, respectively. The FOP 1 of the present embodiment defines the inclination angle α of the input end surface 2 (inclination angle of the input end surface 2 with respect to the optical axis of the optical fiber) so that the light receiving angle becomes 0°. That is, the inclination angle α is set to be an angle which does not cause total reflection on a boundary surface between the core 5 and the cladding 6 irrespective of an angle at which a light is incident into the core 5 from air.

The inclination angle α can be obtained from the following equations.

n0 sin β=n1 sin 90° (condition for total reflection) (1)

n0 sin γ=n sin 90° (condition of light receiving angle 0°) (2)

α+(90°+γ)+(90°−β)=180° (3)

In this case, since n0=1.621, n1=1.519, and n=1 according to FIG. 5, α=31.54°. Therefore, if the inclination angle α in FIG. 6 is equal to or smaller than this value, a light which has propagated through air to be incident from the input end surface 2 does not generate total reflection on the boundary surface between the core 5 and the cladding 6 irrespective of the incident angle.

Therefore, part of the light incident into the FOP 1 from the input end surface 2 leaks from the core 5 to the cladding 6 in the process of propagation with repeated refraction to be absorbed by the light absorbing body 7 and is gradually attenuated and disappears. If the inclination angle of the input end surface 2 is set to such an angle, the light which has propagated through air to be incident into the FOP 1 from the input end surface 2 is hardly output from the output end surface 3.

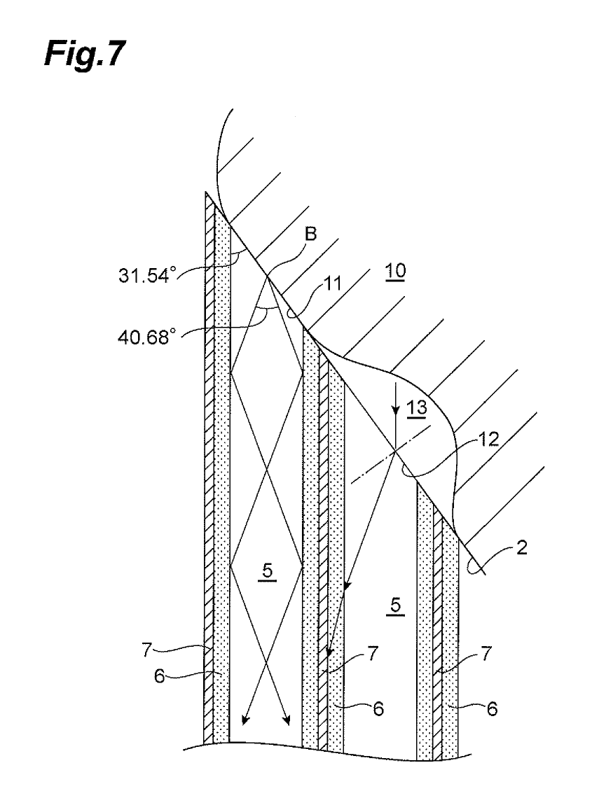

On the other hand, as shown in FIG. 7, if a specific object, for example, a surface of a finger or a palm 10, is brought into close contact with the input end surface 2 in this condition, a closely contacted portion 11 in which the finger or palm surface is closely contacted with the input end surface 2 and a non-closely contacted portion 12 in which a space is generated between the finger or palm surface and the input end surface 2 are formed due to convex and concave portions of the finger print or the palm print. In the closely contacted portion 11, the input end surface 2 and the surface of the finger or the palm 10 are in close contact and the refraction index of the surface of the finger or the palm 10 is greater than the refraction index of air. Therefore, the relationship between the incident angle of the light incident into the input end surface 2 and the condition for total reflection on the boundary surface between the core 5 and the cladding 6 differs from the relationship before the close contact is made and there comes to exist a light which is incident at an angle which satisfies the condition for total reflection on the boundary surface between the core 5 and the cladding 6. For example, it is assumed that a light is irradiated from behind the finger or the palm 10 and a transmitted light thereof reaches a point B (FIG. 7). Among light which is incident into FOP 1 from the point B, a light which is incident within a range of 40.68° as shown in the figure satisfies a condition for total reflection on the boundary surface between the core 5 and the cladding 6 (according to the equation (2)) and therefore, the light incident repeats total reflection on the boundary surface between the core 5 and the cladding 6, and output from the output end surface 3 side. Here, any light which is incident beyond this range of angle is attenuated in the process of propagation with repeated refraction and disappears.

On the other hand, a space 13 as shown in the figure is formed in the non-closely contacted portion 12 and air exists therein. That is, the condition is unchanged from the condition before the finger or the palm 10 is brought into close contact. Therefore, although a light is incident into the core 5 also from the non-closely contacted portion 12 of the input end surface 2, the light does not satisfy the condition for total reflection on the boundary surface between the core 5 and the cladding 6 irrespective of incident angle. Therefore, the light is attenuated in the process of propagating in the core 5 and disappears.

Therefore, in a case where a surface image of an object is thus detected, only a light incident from a convex portion of the surface of the object in close contact with the input end surface 2 is output from the output end surface 3 and a light incident from the concave portion of the surface is attenuated in the process of propagation and disappears. Therefore, unnecessary light such as a background light is eliminated and only an image of a portion which is in a close contact with the input end surface 2 is transmitted to be output.

Here, the example described above is a case where N.A. (numerical aperture)=0.55 and the inclination angles α to other major N.A. are shown in Table 1.

TABLE 1

| | inclination |
|---|---|
| N.A | angles (α) |
| 0.35 | 36.96° |
| 0.55 | 31.54° |
| 0.88 | 25.20° |
| 1.00 | 21.89° |

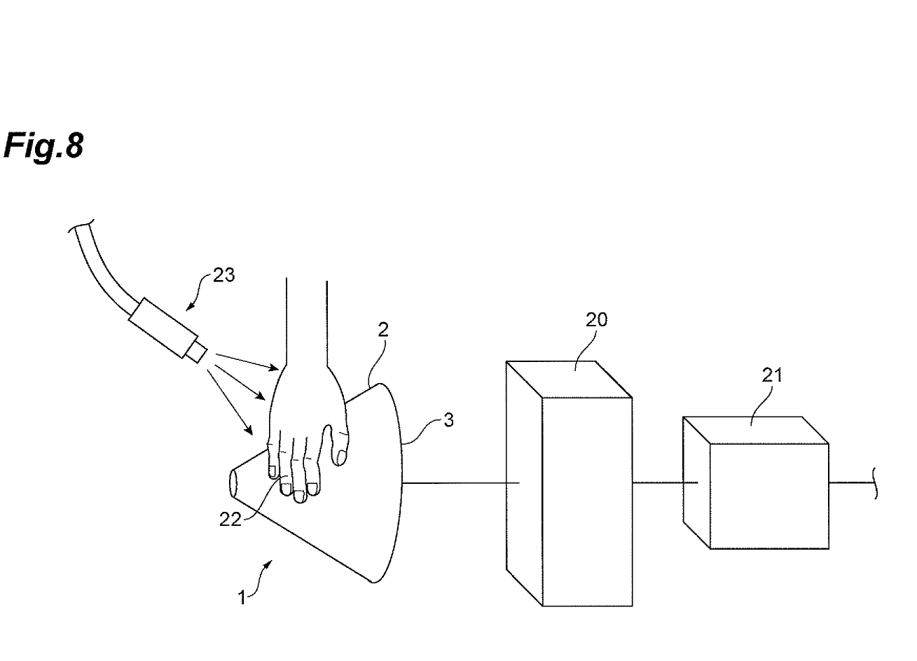

Here, specific configuration of a palm print and finger print reading apparatus including the FOP 1 will be shown. FIG. 8 shows a palm print and finger print reading apparatus, which includes the above-mentioned FOP 1, a CCD 20, a computer 21, and the like. The input end surface 2 of the FOP 1 is formed while being inclined with respect to an optical axis and the inclination angle is set to be equal to or smaller than the inclination angle α obtained by the above-mentioned equations (1) to (3). If either or both of the finger and the palm 10 of a subject are brought into contact with this surface, either or both of the finger and the palm 10 are pressed against the input end surface 2 to be closely contacted and a light is irradiated from a light source 23 provided behind or on a side surface side of the finger or the palm 10. If the finger or the palm 10 is thus closely contacted, convex and concave patterns (image of a finger print or palm print) on the closely contacted portion are transmitted to the output end surface 3, the image data is supplied to the CCD 20, and a signal thereof is image processed by the computer 21.

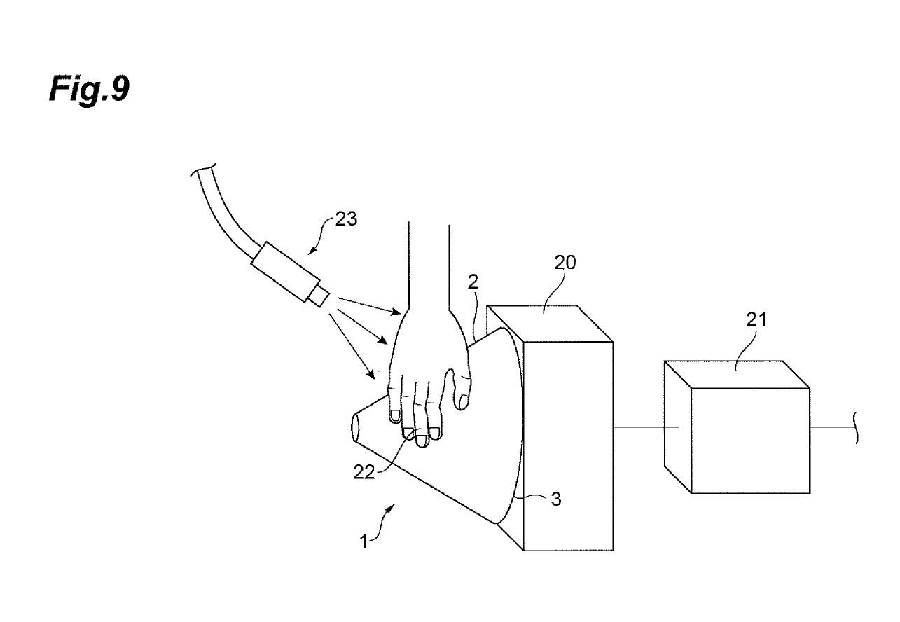

Moreover, another configuration example is shown in FIG. 9. In this example, the output end surface 3 and the CCD 20 of the. FOP 1 are not separated and the CCD 20 can directly take an image of the output end surface 3 without anything between the CCD 20 and the output end surface 3.

Subsequently, operation and effect of the FOP 1 according to the present embodiment will be described. In the present embodiment, the FOP 1 has a conical shape and the side surface of the conical shape is the input end surface 2. Therefore, it is easy for a palm of a photographic subject to be in close contact with the angled input end surface 2 when a palm print is taken (refer to FIGS. 8 and 9) and as a result thereof, it becomes possible to prevent generation of a space between the input end surface 2 and a concave portion at the center of the palm. That is, the angled input end surface 2 has a convex shape and the convex portion fits the concave portion at the center of the palm of the photographic subject and therefore a space is hardly generated between the input end surface 2 and the concave portion at the center of the palm. Therefore, it becomes possible to obtain a clearer output image compared to a case of placing a palm on a flat surface or concave portion when a palm print is taken.

Moreover, the light absorbing body 7 is provided so as to cover the external periphery of the cladding 6 in the unit fiber 4 so that a light leaked from the core 5 and a light propagating the cladding 6 reach the light absorbing body 7. Since these lights are absorbed by the light absorbing body 7 when the lights are incident into the light absorbing body 7, the adjacent optical fibers are optically insulated from each other by the light absorbing body 7. Therefore, it becomes possible to prevent a light propagating each of the cores 5 which leaks from the core 5 from being incident into another adjacent core 5. In addition, if the inclination angle of the input end surface 2 of the FOP 1 is set as above, part of the light which has propagated through air to be incident into the core 5 from the input end surface 2 leaks from the core 5 to the cladding 6 and is absorbed by the light absorbing body 7. Therefore, unnecessary light such as the background light is gradually attenuated in the process of propagating through the core 5 and is hardly output from the output end surface 3. On the other hand, in a case where a surface of an object is brought into close contact with the input end surface 2, a light which passed through the closely contacted portion 11 is incident into the core 5. However, the incident light includes a light which is incident at an angle which satisfies a condition for the total reflection on the boundary surface between the core 5 and the cladding 6. That is, only the light incident from the closely contacted portion 11 is output from the output end surface 3. Thus, even if the palm which is a photographic subject is sweaty or dry, it becomes possible to obtain a clear output image when a palm print is taken.

Further, placing not only a palm but all the fingers on the input end surface 2 being the side surface of the conical shape enables to obtain both a palm print and finger prints simultaneously. Especially regarding finger prints, finger prints of all five fingers can be taken simultaneously.

The preferred embodiment of the present invention has been described above. However, it is a matter of course that the present invention is not limited to the embodiment described above.

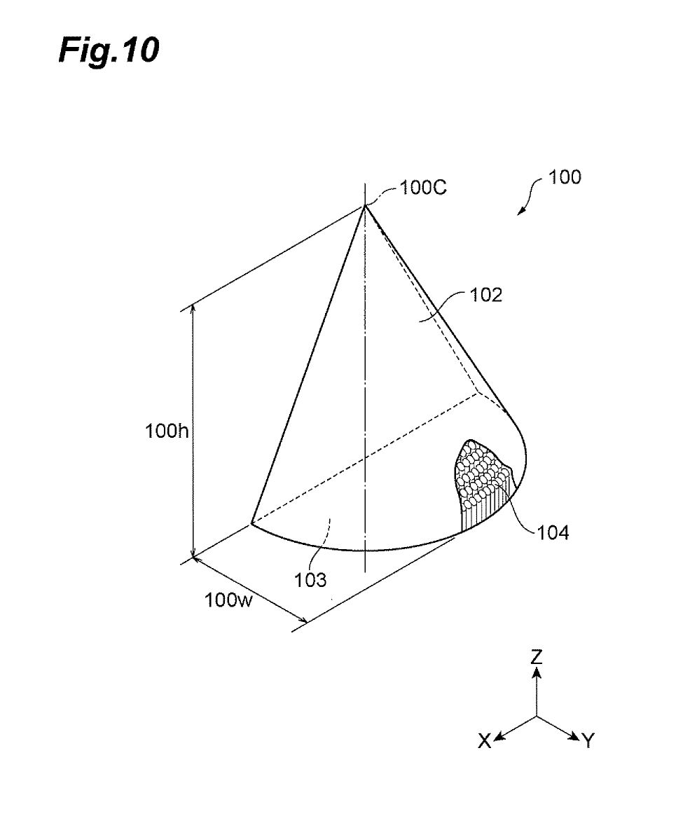

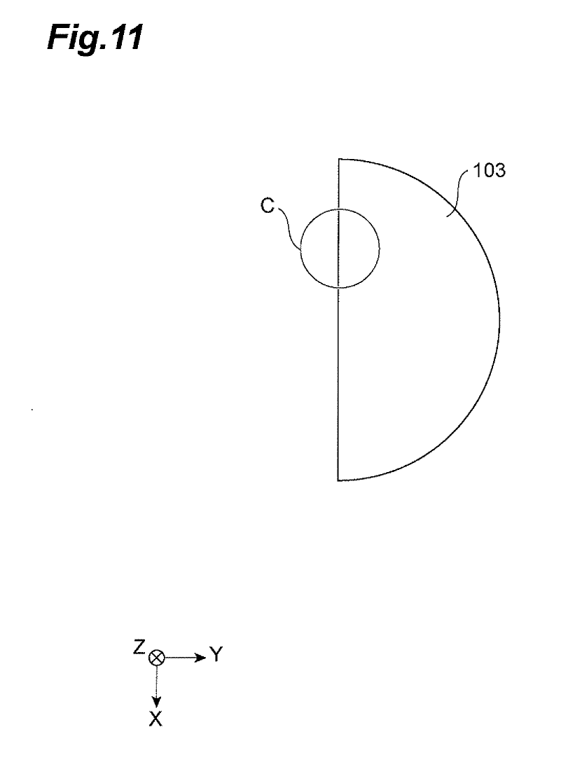

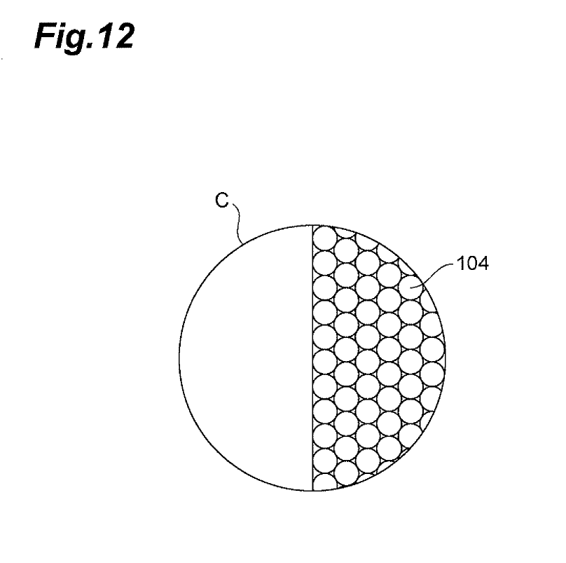

For example, as shown in FIGS. 10 to 12, an FOP 100 may be configured in a shape formed by cutting the conical shape (one similar to the above-mentioned FOP 1) having a height 100h in an optical axis direction of a unit optical fiber 104 into half with a center axis 100C of the conical shape as a fiducial point for cutting (width 100w is ½ of the width w in FIG. 1). FIG. 10 is a partly sectional perspective view of the FOP 100, FIG. 11 is a rear elevational view of the FOP 100, and FIG. 12 is an enlarged view of a part C of FIG. 11. The FOP 100 shown in FIGS. 10 to 12 includes a plurality of unit optical fibers 104, which are bundled in a condition where respective optical axes of the unit optical fibers are approximately parallel to each other, and an input end surface 102 and an output end surface 103 configured by respectively assembling both end surfaces of the unit optical fibers 104, similar to the FOP 1 shown in FIGS. 1 to 3. The input end surface 102 configures a side surface of the original conical shape while the output end surface 103 configures a bottom surface of the original conical shape. In this FOP 100 as well, if either or both of a finger and a palm of a photographic subject are brought into contact with the input end surface 102, a light which is incident from the input end surface 102 is output from the output end surface 103. Moreover, the input end surface 102 is inclined with respect to an optical axis of the fiber (as mentioned regarding the input end surface 2) and the output end surface 103 is formed to be approximately perpendicular to the optical axis.

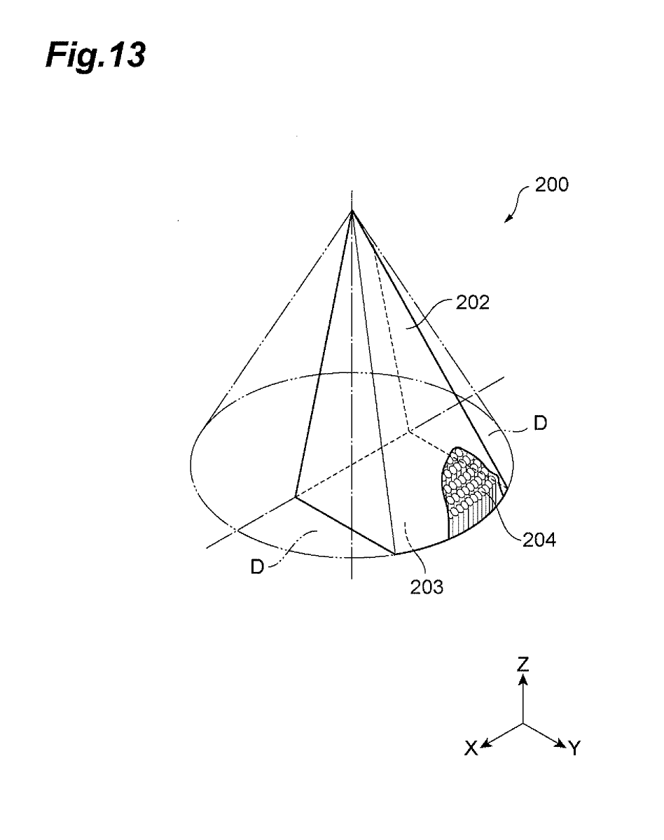

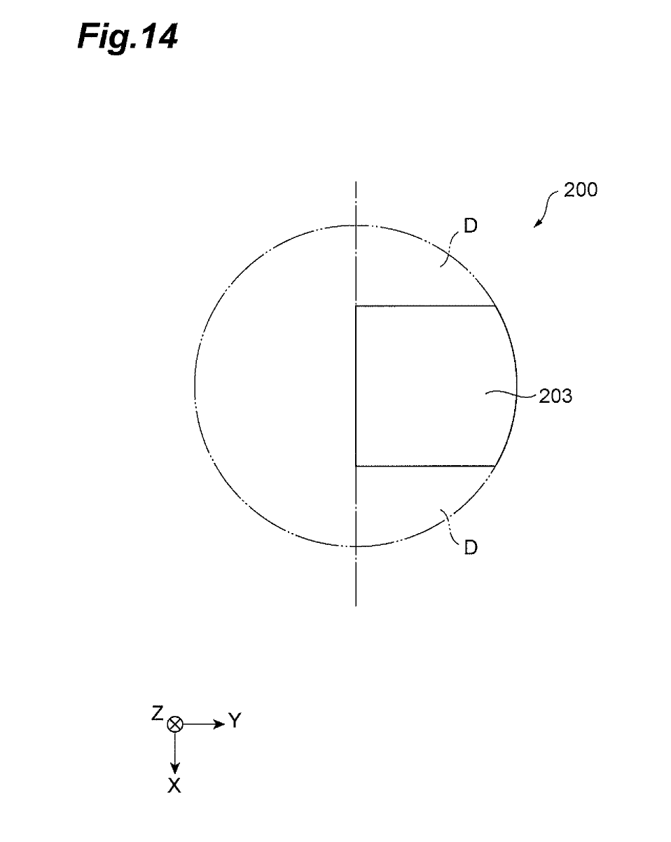

Further, as shown in FIGS. 13 and 14, a shape formed by cutting the conical shape having the height 100h in the optical axis direction of the unit optical fiber 104 into half with the center axis 100C of the conical shape as a fiducial point for cutting (one which is similar to the FOP 100) may further be cut suitably to configure an FOP 200. FIG. 13 is a partly sectional perspective view of the FOP 200 and FIG. 14 is a rear elevational view of the FOP 200. In FIGS. 13 and 14, a part D indicates the cut out portion and a reference numeral 203 indicates an output end surface of the FOP 200.

What is claimed is:

1. A fiber optic plate comprising a plurality of unit fibers, which are bundled in a condition where respective optical axes of the unit fibers are parallel to each other, and an input end surface and an output end surface configured by respectively assembling both end surfaces of the unit fibers, wherein
the fiber optic plate has a conical shape having a height in the optical axis direction;
the input end surface configures a side surface of the conical shape;
the output end surface configures a bottom surface of the conical shape;
a light incident from the input end surface is output from the output end surface if either or both of a finger and a palm of a photographic subject are brought into contact with the input end surface;
the unit fiber has a core for propagating the light which is incident from the input end surface, a cladding for covering an external periphery of the core, and a light absorbing body for absorbing an incident light while covering an external periphery of the cladding; and
the input end surface is inclined with respect to the optical axis of the core and the angle of inclination is set so that the light incident from air into the core does not generate total reflection at a boundary surface between the core and the cladding.

2. The fiber optic plate according to claim 1, wherein the fiber optic plate has a shape formed by cutting the conical shape into half with a center axis of the conical shape as a fiducial point for cutting.

3. A palm print and finger print reading apparatus comprising:
a fiber optic plate comprising a plurality of unit fibers, which are bundled in a condition where respective optical axes of the unit fibers are parallel to each other, and an input end surface and an output end surface configured by respectively assembling both end surfaces of the unit fibers, wherein the fiber optic plate has a conical shape having a height in the optical axis direction; the input end surface configures a side surface of the conical shape; the output end surface configures a bottom surface of the conical shape; a light incident from the input end surface is output from the output end surface if either or both of a finger and a palm of a photographic subject are brought into contact with the input end surface; the unit fiber has a core for propagating the light which is incident from the input end surface, a cladding for covering an external periphery of the core, and a light absorbing body for absorbing an incident light while covering an external periphery of the cladding; and the input end surface is inclined with respect to the optical axis of the core and the angle of inclination is set so that the light incident from air into the core does not generate total reflection at a boundary surface between the core and the cladding;
a charge coupled device (CCD) for receiving a light output from an output end surface of the fiber optic plate; and
a computer device for receiving a signal output from the CCD.

4. The palm print and finger print reading apparatus according to claim 3, wherein the output end surface of the fiber optic plate and the CCD are not separated and an image of the output end surface can be directly taken by the CCD.

5. The palm print and finger print reading apparatus according to claim 3, wherein the fiber optic plate has a shape formed by cutting the conical shape into half with a center axis of the conical shape as a fiducial point for cutting.

6. The palm print and finger print reading apparatus according to claim 4, wherein the fiber optic plate has a shape formed by cutting the conical shape into half with a center axis of the conical shape as a fiducial point for cutting.
